(19) United States
(12) Patent Application Publication
(10) Pub. No.: US 2009/0312442 A1
(43) Pub. Date: Dec. 17, 2009

(54) EMULSIFYING DEVICE AND PROCESS FOR FORMING AN EMULSION

(75) Inventor: Stephan Herminghaus, Goettingen (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Max-Planck-Gesellschaft zur Foerderung der Wissenschaften e.V., Munich (DE)

(21) Appl. No.: 12/376,208

(22) PCT Filed: Aug. 3, 2007
(86) PCT No.: PCT/EP07/06899

§ 371 Date: Mar. 3, 2009

(30) Foreign Application Priority Data
Aug. 7, 2006 (DE) 10 2006 036 815.0

(51) Int. Cl. B01F 3/08; B01F 5/08

(52) U.S. Cl. 516/9; 366/153.2

(57) ABSTRACT

An emulsifying device (100) for forming an emulsion (1) having a continuous phase (2) and at least one dispersed phase (3.1, 3.2) includes a dispersion region (10) for forming the emulsion (1), a channel (20) which leads to the dispersion region (10) and is designed to accommodate laminar-flowing liquid filaments of the continuous and dispersed phases (2, 3.1, 3.2), a feed line (30) for feeding the continuous phase (2) into the channel (20), and at least one injection line (40, 41) for supplying the at least one dispersed phase (3.1, 3.2) into the channel (20), wherein the at least one injection line (40, 41) is connected to the channel (20) via a multitude of injection bores (42), and the dispersion region (10) includes a gap opening (11) of the channel (20) which opens into an environment of the emulsifying device (100). A process is also described for forming an emulsion (1) having a continuous phase (2) and at least one dispersed phase (3.1, 3.2).

The invention relates to an emulsifying device for forming an emulsion with a continuous and at least one dispersed phase, especially an emulsifying device with a channel (or: gap) that is configured to accommodate laminar flowing liquid filaments of the different phases and that comprises a channel widening at which the at least one dispersed phase disintegrates into individual drops. Furthermore, the invention relates to a process for forming an emulsion with a continuous phase and at least one dispersed phase, especially a process for producing a mixed emulsion with several dispersed phases. The invention especially relates to an emulsifying device and to an emulsifying process with the features of the generic parts of the independent claims.

A conventional emulsifying device 100′ for forming an emulsion from a continuous phase and at least one dispersed phase that was described by C. Priest et al. in “Applied Physics Letters” (volume 88, 2006, 024106-01)is schematically illustrated in FIG. 11. The emulsifying device 100′ comprises a dispersion region 10′ formed as part of a channel 20′ in the interior of a fluidic microsystem. The channel 20′ is connected to a feed line 30′ for feeding the continuous phase 2′ and with an injection line 40′ for feeding the dispersed phase 3′. Bottom and cover walls of the channel 20′ have such a slight vertical distance that the liquids of the continuous and dispersed phases, that are not miscible with each other, in the channel 20′ flow adjacent to each other as thin filaments. The boundary surface separating the two liquids extends between the bottom and cover walls. The continuous and dispersed phases form a dynamically stable, laminar flow. In the dispersion region 10′ the channel 20′ widens with step shape. An edge 11′ is provided on which the filamentary liquid flows become unstable and disintegrate into individual drops. In the dispersion region 10′ the dispersed phase 3′ is distributed in a drop-shaped manner in the continuous phase 2′ so that the phases 2′, 3′ flow further as emulsion 1′ in the channel 20′ downstream from the dispersion region 10′.

The conventional emulsifying device 100′ in accordance with FIG. 11 has the disadvantage that the dispersion region 10′ with the widening channel 20′ is located in the interior of the microsystem. The drops of the dispersed phase are produced substantially in series. As a result, only small emulsion amounts can be produced with the conventional emulsifying device 100′ that are too small for practical applications, for example, in the liquid phase engineering. In order to enlarge the emulsion amount a plurality of emulsifying devices 100′ would have to be combined, which, however, constitutes an unacceptably high expense for technical devices.

A further general problem of the conventional liquid phase engineering consists in the controlling of chemical reactions between initial substances that are mixed in the liquid state. It is undesired in many applications that the reactions between the initial substances begins spontaneously already at the beginning of the mixing. Since the mixing process has a certain duration, the mixing ratio of the substances reacting with each other during the mixing and the further reaction is not constant. As a result, limitations can occur at the adjusting of a certain reaction stoichiometry or of other reaction conditions. This problem represents a significant disadvantage in particular in the production of high-grade chemical special products with a certain chemical composition. For example, during the production of semi-conductor nanoparticles from the liquid phase a relatively broad distribution of size of the nanoparticles also had to be previously accepted.

A solution of this problem could be reached with a mixture of the different liquids that are not based on the phenomenon of turbulence but rather on a common emulsifying. During the emulsifying a mixed emulsion with a certain mixing ratio can be instantaneously adjusted that is then constant for the entire duration of the reaction. As a consequence, the phase boundaries existing at first in the emulsion can be interrupted by an external influence such as, for example, a microwave field or an electrical voltage in order to obtain a defined starting time for the beginning of the reaction of the liquids.

The conventional emulsifying device 100′ has, in addition to the named problem of the low emulsion yield, the additional disadvantage that it is suitable only to a limited extent for the production of a mixed emulsion. Previously, in particular no possibility was published about how a mixed emulsion could be produced with the conventional emulsifying device 100′.

The invention is based on the objective of providing an improved emulsifying device available with which the disadvantages of the conventional emulsifying techniques are overcome. The invention is furthermore based on the objective of providing an improved emulsifying process which allows overcoming the disadvantages of the conventional emulsifying techniques. The emulsifying device and the emulsifying process should in particular have an expanded range of application and be especially suited for the production of mixed emulsions.

These objectives are solved by an emulsifying device and a process with the features of the independent claims. Advantageous embodiments and applications of the invention result from the dependent claims.

According to a first aspect, the invention is based on the general technical teaching of providing an emulsifying device for forming an emulsion with a continuous phase and at least one dispersed phase that comprises a dispersion region for forming the emulsion by a disintegration of laminar flows of the continuous and of the at least one dispersed phase, wherein a channel for receiving the laminar flows and a plurality of injection bores are provided through which the at least one dispersed phase can be injected into the channel, and the dispersion region is formed by a gap opening of the channel that opens directly into a free environment of the emulsifying device.

A compact emulsion source is advantageously created by the combination in accordance with the invention of a plurality of injection bores emptying into the channel with a dispersion region formed by a channel end, with which emulsion source an emulsion can be provided directly in a reaction vessel with practical, interesting rates and volumes. The injection bores make it possible that numerous liquid filaments are formed in the channel at the same time from a single or several, e.g., two different dispersed phases and flow to the dispersion region. In deviation from the conventional serial production of emulsions, a parallel production of emulsions is made possible.

According to a second aspect the invention is based on the general technical teaching of providing an emulsifying process wherein the continuous phase and the at least one dispersed phase exit in the form of a plurality of laminar liquid filaments flowing adjacent to each other from a channel at a gap opening into a free environment in order to form the emulsion.

The emulsifying device in accordance with the invention contains a feed line for feeding the continuous phase into the channel. At least adjacently to the channel, the feed line has a straight direction defining an axial reference direction (z-direction) of the emulsifying device. The exiting of the emulsion from the emulsifying device can also take place parallel to the axial reference direction (first embodiment of the invention) or in a direction deviating from the axial reference direction, in particular, in a plane vertical to the axial reference direction, i.e., in a radial reference direction (x-direction) (second embodiment of the invention). The emulsifying device in accordance with the invention furthermore contains at least one injection line for feeding the dispersed phase into the channel. The dispersed phase is distributed from each injection line via the injection bores in the channel.

The term “channel” or “gap” designates here in general a volume region between the injection bores and the dispersion region that is limited by walls with such a small vertical distance that liquids injected through the injection bores form laminar flows. The terms “continuous phase” and “dispersed phase” designate liquids in general here. The liquid of the dispersed phase (reactant, e.g., aqueous solution) is immiscible with the liquid of the continuous phase (carrier liquid, e.g., an oil). The concept “environment of the emulsifying device” designates a region bordering on the gap opening of the channel in which the emulsion can freely spread out in at least two spatial directions.

A broad variability in the geometric shaping of the dispersion region and of the orientation of the channel is advantageously given. According to a preferred embodiment of the invention the gap opening has a curved course of the opening so that the spatial density and in this case the yield of the emulsion formation can advantageously be enlarged. The dispersion region can extend in the reaction vessel for receiving the emulsion with an edge curved vertically to the axial extension of the emulsifying device whose length is greater than would be the case for a straight opening course. An endless gap opening with a closed opening course is especially preferred, e.g., with a circular opening course (ring gap). If the gap opening of the channel is designed to be circular, this can result in advantages for the adaptation of the outlet of the emulsion in axial or radial direction relative to the axial reference direction of the emulsifying device.

Two injection lines for feeding the at least one dispersed phase into the channel are preferably provided in the emulsifying device in accordance with the invention each having a plurality of injection bores. The injection bores open in opposite, e.g., upper and lower side walls into the channel. As a result, the feed of a dispersed phase with a high filament density in the channel and/or the separate feed of various dispersed phases into the channel are simplified. The openings of the injection bores into the channel are distributed transversely to the direction of flow in the channel in such a manner that a laminar liquid filament toward the opening of the channel can be formed by each injection bore. The at least one dispersed phase can be advantageously distributed with the injection bores via the channel in its transversal direction.

A variant of the invention is especially preferred in which the two injection lines are provided for feeding different dispersed phases into the channel. For this, the injection lines are connected to separate reservoirs of a fluidic device that contain the dispersed phases. The emulsifying device can advantageously be used in this case for the mixing of the dispersed phases.

According to a further advantageous variant of the invention the injection bores comprise funnel-shaped injection openings via which the injection line(s) is (are) connected to the injection bores. This advantageously reduces the flow resistance in the feed of the at least one dispersed phase. The funnel-shaped injection openings of adjacent injection bores can be connected by a groove, for example, a ring groove. This advantageously simplifies the introduction of the at least one dispersed phase into the injection bores.

If the channel runs parallel to the axial reference direction of the emulsifying device (first embodiment of the invention) the emulsion can be advantageously put out in a single direction into a reaction vessel. In the first embodiment of the invention the injection bores preferably run in radial direction, that is, vertically to the axial reference direction of the emulsifying device. If, according to a preferred variant, the at least one injection line and the feed line are arranged coaxially relative to one another, this can result in advantages for a compact design of the emulsifying device. In this case the emulsifying device can advantageously have an outer form of a cylinder in which the injection line and the feed line run axially and the dispersion region is formed on its free end (front side).

If the channel running to the dispersion region is aligned in radial direction, that is, vertically to the axial reference direction of the emulsifying device (second embodiment of the invention), this can result in advantages by a radial outputting of the emulsion in different directions relative to the emulsifying device. The channel preferably runs in radial direction from the feed line to an inner or outer circumferential edge of the emulsifying device. In this case the injection bores can advantageously be aligned parallel to the axial reference direction of the emulsifying device.

In the second embodiment of the invention the channel is formed especially preferably as plane gap between two plates extending in radial direction, that is, vertically to the axial reference direction of the emulsifying device. The injection bores can advantageously be arranged in one or both of the plates in order to correspondingly open on one side or both sides into the channel. The injection bores opening on both sides into the channel are preferably arranged staggered azimuthally relative to each other for the production of mixed emulsions. In this case different dispersed phases can be introduced alternately adjacent to each other into the channel.

Further details and advantages of the invention are described in the following with reference made to the attached drawings, which show in

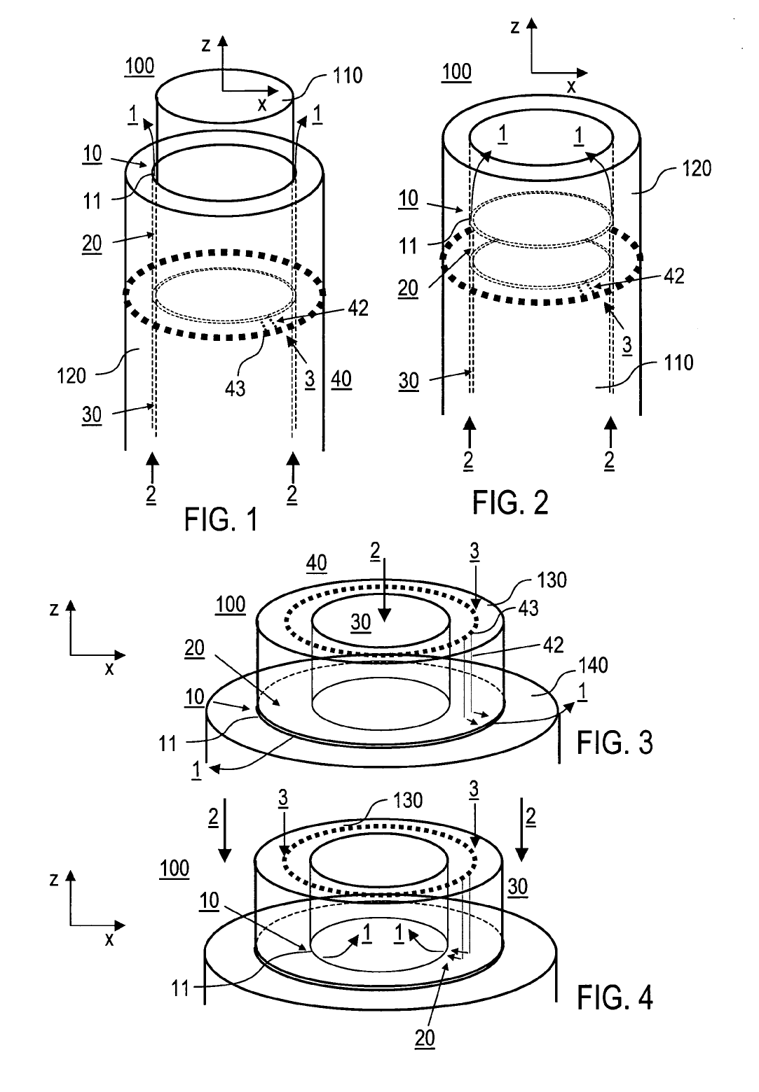

FIGS. 1 and 2: schematic illustrations of two variants of the first embodiment of the emulsifying device in accordance with the invention with an axially opening dispersion region;

FIGS. 3 and 4: schematic illustrations of two variants of the second embodiment of the emulsifying device in accordance with the invention with a radially opening dispersion region;

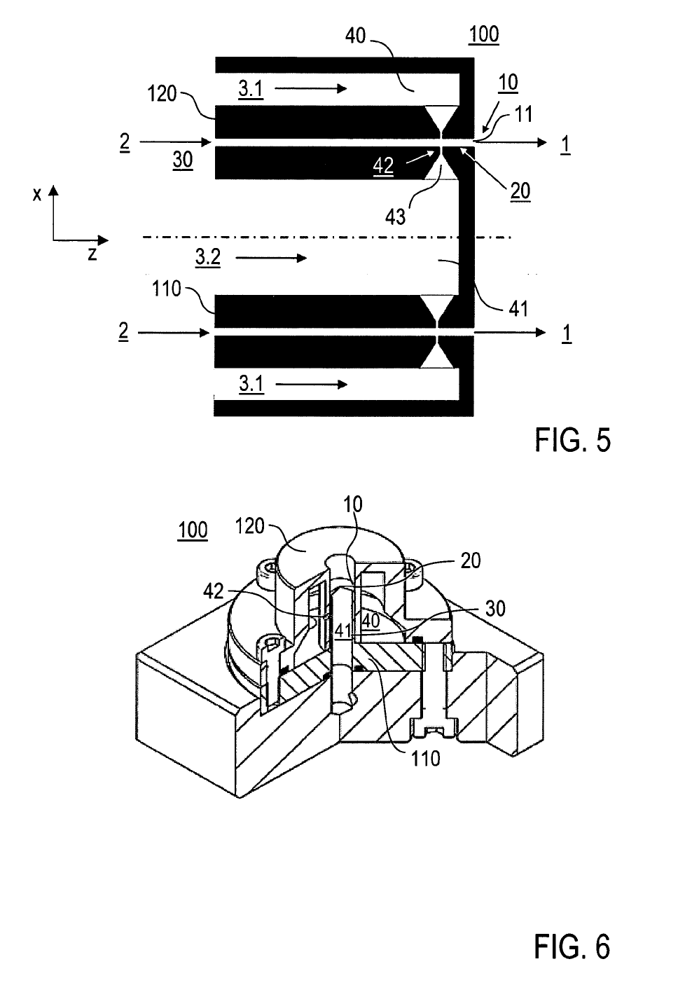

FIGS. 5 and 6: illustrations of further details of the first embodiment of the emulsifying device in accordance with the invention;

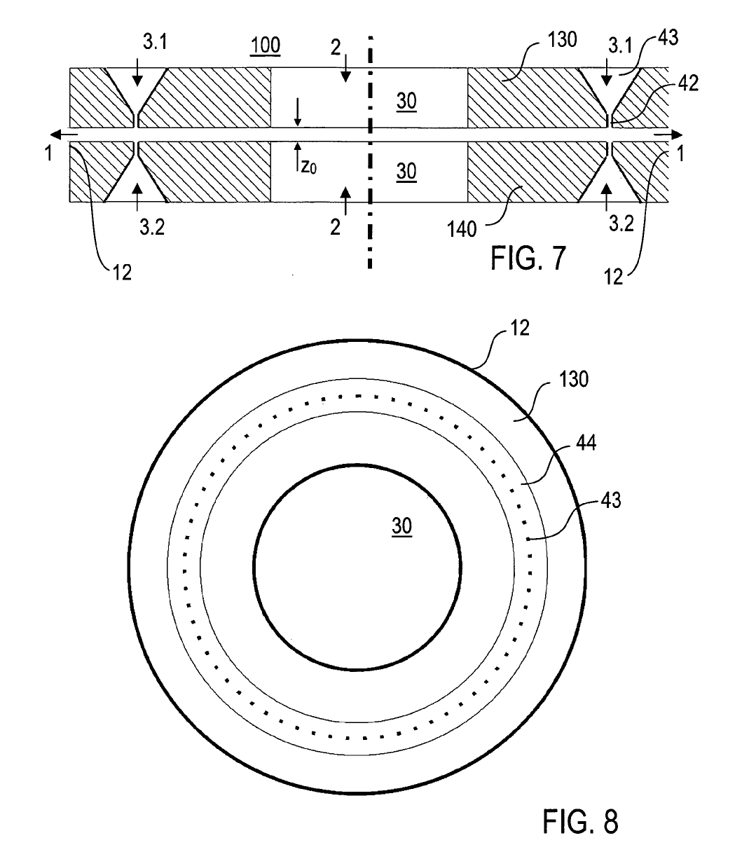

FIGS. 7 to 10: illustrations of further details of the second embodiment of the emulsifying device in accordance with the invention; and

FIG. 11: a schematic illustration of a conventional emulsifying device.

Referring to the FIGS. 1 to 4, at first the geometry and in particular the mutual alignment of the feed line, the injection bores and of the channel with the dispersion region in the emulsifying device in accordance with the invention are described. Details of the liquid transport into the feed line and the injection bores are shown by way of example in the FIGS. 5 to 10. The described emulsifying device is connected to a fluidic device for the supply of liquid and control of the emulsifying device. Details of the fluidic device (not shown), such as, e.g., liquid reservoirs, delivery pumps, lines, valves and the like are known and are therefore not described here.

FIG. 1 shows the first embodiment of the emulsifying device 100 in accordance with the invention with an inner part 110 and an outer part 120. The inner part 110 has the form of a straight circular cylinder with an outside diameter that is smaller than the inside diameter of the outer part 120 with the shape of a hollow cylinder. The cylinder axes of the concentrically arranged inner and outer parts 110, 120 form the axial reference direction (z) of the emulsifying device 100.

The channel 20 (gap 20) is formed between the inner and outer parts 110, 120 and runs to the dispersion region 10. The channel 20 is set to receive a liquid layer with the shape of a hollow cylinder from the continuous and dispersed phases 2, 3 that form laminar liquid filaments during the feed of liquid that flow to the dispersion region 10. The distance between the outside diameter of the inner part 110 and the inside diameter of the outer part 120 (radial channel height) is selected in such a manner that boundary surfaces extend between the continuous and dispersed phases 2, 3 between the inner and outer parts 110, 120. The radial channel height is selected, for example, in the range of 1 μm to 0.1 mm.

The dispersion region 10 is formed by the opening of the channel 20 into the environment of the emulsifying device 100. The circular opening 11 is formed by the cylinder surface of the inner part 110 and the circular inner edge of the outer part 120, at which opening the channel 20 widens out by step in the radial direction. The laminar liquid filaments of the continuous and dispersed phases 2, 3 in the channel 20 become unstable at the gap opening 11 in accordance with the mechanism described by C. Priest et al., so that they disintegrate into individual drops. The drop size is substantially determined by the radial channel height that is equally large for all drops, so that a monodisperse distribution of drop sizes is advantageously produced. The drop size can furthermore be influenced by a filling pressure or a delivery amount of the dispersed phases in the injection lines. The filling pressure and/or the delivery amount of the dispersed phases can be adjusted in each injection line, e.g., with a delivery pump, in particular a syringe pump.

The feed of the continuous phase 2 into the channel 20 takes place through the feed line 30. The feed line 30 is formed like the channel 20 by the distance between the inner and outer parts 110, 120. This distance is preferably identical in the regions of the channel 20 and of the feed line 30 so that the channel 20 essentially constitutes a continuation of the feed line 30. Alternately, the radial channel height in the channel 20 can deviate from the channel height in the feed line, especially can be smaller.

Radially aligned injection bores 42 run to the channel 20 from an outer injection line 40 that surrounds the outer part 120 and whose walls are not shown in FIG. 1 (see also FIG. 5). For reasons of clarity only two injection bores 42 are shown. Each injection bore 42 extends from an injection opening 43 in the outer surface of the outer part 120 to the channel 20.

In order to produce an emulsion 1 comprising the continuous phase 2 and the dispersed phase 3 the continuous phase 2 is conducted through the feed line 30 into the channel 20. At the same time the feed of the dispersed phase 3 takes place through the injection bores 42 also into the channel 20. In the channel 20 the flows of the continuous and dispersed phases 2, 3 flow as laminar liquid filaments to the dispersion region 10, at which the drop formation takes place. The flow of the liquid filaments in the gap-shaped channel 20 represents an essential feature for the production of monodisperse emulsions. Without the channel 20 the dispersed phase would fall apart during the exiting from small holes directly into the free environment even into individual drops that, however, would have a polydisperse size distribution.

The drops of the dispersed phase 3 flow in the variant according to FIG. 1 in axial direction and with increasing distance from the gap opening 11 radially outward, since the inner part 110 continues over the radial length of the outer part 120. Deviating from this geometry, the outer part 120 can continue over the axial end of the inner part 110, as is schematically illustrated in FIG. 2. In the emulsifying device 100 according to FIG. 2 the dispersion region 10, the channel 20, the feed line 30 and the injection bores 42 are arranged as in FIG. 1, and the emulsion 1 exiting through the gap opening 11 into the environment is limited radially toward the inside by the limiting effects of the outer part 120.

The FIGS. 3 and 4 show two variants of the second embodiment of the invention, in which the feed line 30 also runs in axial direction of the emulsifying device 100; however, the channel 20 is aligned, in distinction to the first embodiment (FIGS. 1, 2), in radial direction.

According to FIG. 3 the emulsifying device 100 comprises an upper part 130 and a lower part 140. The upper and lower parts 130, 140 are arranged at a distance relative to one another and the channel 20 is formed between the plane side surfaces of the upper and lower parts 130, 140, which side surfaces face each other. The upper part 130 has a form of a straight hollow cylinder. The feed line 30 for the feed of the continuous phase 2 into the channel 20 is provided in the interior of the upper part 130. The injection bores 42 also run in axial direction in the upper part 130. They extend parallel to the feed line 30 from the injection openings 43 to the channel 20. Again, for reasons of clarity only two injection bores 42 are illustrated.

For the formation of an emulsion 1 in accordance with the invention the continuous phase 2 is conducted through the feed line 30 into the channel 20. Furthermore, the dispersed phase 3 is conducted from an injection line 40 above the upper part 130 via the injection bores 42 into the channel 20. In channel 20 the continuous and dispersed phases 2, 3 form laminar liquid filaments that flow radially outward and disintegrate into individual drops at the ring-shaped gap opening 11 of the dispersion region 10 in accordance with the above-described mechanism.

FIG. 4 shows a modified variant of the second embodiment of the emulsifying device 100 in accordance with the invention in which the feed line 30 is formed outside of the upper part 130 and the continuous and dispersed phases 2, 3 in the channel 20 flow radially inward. Accordingly, the emulsion 1 is produced in the interior of the upper part 130 with the shape of a hollow cylinder.

If the injection bores 40 of the emulsifying device 100 in accordance with FIGS. 1 or 2 are alternately loaded with different dispersed phases, a mixed emulsion can accordingly be produced. The construction of the emulsifying device 100 for producing the mixed emulsion can be simplified if the different dispersed phases 3 are injected on both sides into the channel 20. Details of corresponding variants of the first embodiment of the emulsifying device in accordance with the invention are illustrated in the FIGS. 5 and 6.

According to FIG. 5 the emulsifying device 100 has a concentric construction of the inner- and outer parts 110, 120. The outer part 120 comprises a hollow cylinder in whose wall a first injection line 40 runs. The first dispersed phase 3.1 can be injected from the first injection line 40 via outer injection bores 42 into the channel 20. The inner part 110 also comprises a hollow cylinder in which a second injection line 41 runs from which the second dispersed phase 3.2 can be injected via inner injection bores 42 into channel 20. The injection bores 42 each have funnel-shaped injection openings 43. The channel 20 and the feed line 30 are formed by the distance between the inner and outer parts 110, 120, as is described above. The variant of the first embodiment of the invention shown in FIG. 5 has the advantage that the mixed emulsion 1 is produced on the front side of the emulsifying device 100 with a high density.

In order to produce a mixed emulsion 1 with the emulsifying device 100 according to FIG. 5 the continuous phase 2 and the dispersed phases 3.1, 3.2 are introduced into the channel 20. In the channel 20 laminar liquid filaments are formed and the first and second dispersed phases are preferably arranged adjacent to each other in an alternating manner. During the exiting from the circular gap opening 11 the dispersed phases disintegrate in accordance with the above-described mechanism into individual drops that are distributed in the continuous phase. The mixing ratio of the dispersed phases 3.1, 3.2 in the continuous phase 2 can be adjusted by the volume flows in the first and second injection lines 40, 41.

A drop size ratio can also be advantageously adjusted by the selection of a predetermined ratio of the volume flows. The drops with defined drop number densities form a specific arrangement in the structure of the emulsion as a function of the drop size ratio.

A further variant of the first embodiment of the emulsifying device 100 in accordance with the invention is illustrated in FIG. 6 by way of example. As in the concentric variant according to FIG. 5 the emulsifying device 100 comprises the inner part 110 and the outer part 120, in which the injection lines 41, 40 are arranged. The feed line 30 in the gap between the inner and outer parts 110, 120 is connected via a line connection (not shown) to a reservoir of the continuous phase. The first and second injection lines 40, 41 are
correspondingly connected to reservoirs of the first and second dispersed phases. The injection bores are located in the immediate vicinity of the dispersion region 10. The axial length of the channel 20 from the injection bores to the gap opening can be selected to be so small that the stabile laminar liquid filaments are formed in the channel 20. The axial length of the channel 20 can, for example, be selected in the range of 10 μm to 1 mm.

The emulsifying device 100 according to FIG. 5 or 6 is produced in that the inner and outer parts 110, 120 are provided by mechanical shaping (for example turning) and are provided with the injection bores 42 and the injection openings 43. The bores can be produced, for example, by electrical erosion. Alternatively, available lithography processes, etching processes and/or galvanic techniques can be used.

The emulsifying device 100 according to FIG. 6 was tested in the practice in which water was conducted through the first injection line 40 and an oil-surfactant mixture (mono-olein in tetradecane) through the second injection line 41 to the dispersion region 10. Within a few seconds a volume of around one eighth of a cubic centimeter was able to be filled with a mixed emulsion of the two dispersed phases. The radial channel height (distance of the inner and outer parts 110, 120) was 50 μm. The diameter of the injection bores was around 100 μm. The drop size of the dispersed phases was around 200 μm. In order to produce smaller drop diameters the injection bores can be provided available with a correspondingly reduced diameter.

FIGS. 7 and 8 show further variants of the second embodiment of the emulsifying device 100 in accordance with the invention for the production of a mixed emulsion flowing radially outward to a circumferential edge 12 of the emulsifying device 100 (see FIG. 3). FIG. 7 shows in a schematic sectional view the parts of the emulsifying device 100 for the production of the mixed emulsion 1. The upper- and lower parts 130, 140 comprise two round plates that have two plane side surfaces spaced in accordance with the desired channel height z₀. FIG. 8 illustrates the top view onto the upper part 130.

The feed line 30 for feeding the continuous phase 2 is provided in the middle of the upper- and lower parts 130, 140. The injection bores 42 comprise funnel-shaped injection openings 43 connected via a ring groove 44. In distinction to FIG. 3 injection bores 42 are provided in the upper part 130 as well as in the lower part 140. Different dispersed phases 3.1, 3.2 are introduced into the channel from the two sides of the channel 20.

The construction according to FIGS. 7 and 8 can be realized, for example, with the following dimensions. The upper and lower parts 130, 140 have a diameter of 2 cm. The distance z₀ of the upper and lower parts 130, 140 and therewith the axial channel height is preferably selected comparable to the diameter of the injection bores 42 or smaller than it, for example, in the range of 1 μm to 0.1 mm. The numbers of injection bores 42 in the upper and lower parts 130, 140 are preferably equal (for example 240). The hole circle formed by the injection bores 42 has a radius of around 8 mm. The injection bores 42 are arranged on the hole circle with a distance that is preferably selected to be greater than the double bore diameter, for example, in the range of 5 μm to 0.5 mm, and is e.g., at a diameter of 30 μm around 120 μm. Accordingly, 480 liquid filaments each with a width of around 30 μm can be formed. The width of the liquid filaments grows slightly in radial direction since the liquids flow slower toward the outside on account of the growing circumference.

The upper and lower parts 130, 140 are arranged rotated relative to one another in such a manner that the injection bores 42 have different azimuth angles relative to the radial reference direction of the emulsifying device 100. Thus, the different dispersed phases can be advantageously arranged adjacent to each other in the channel 20.

In order to produce a mixed emulsion 1 the continuous phase 2 and the dispersed phases 3.1, 3.2 are introduced into the channel 20. A liquid filament is formed from each liquid entering through one of the injection bores 42 into the channel 20, the boundary surface of which filament relative to the liquid of the continuous phase 2 is fixed between the walls of the channel 20, that is, between the upper and lower parts 130, 140. A collar of liquid filaments that flow outward in a radial and laminar manner in the flow of the continuous phase 2 is produced in the gap-shaped channel 20 by loading all injection bores 42 with dispersed phases. The different dispersed phases 3.1, 3.2 are arranged adjacent to one another in an azimuthally alternating manner. If the liquid filaments flow outward through the circular gap opening 11 of the dispersion region 10, they disintegrate in the free environment into individual drops.

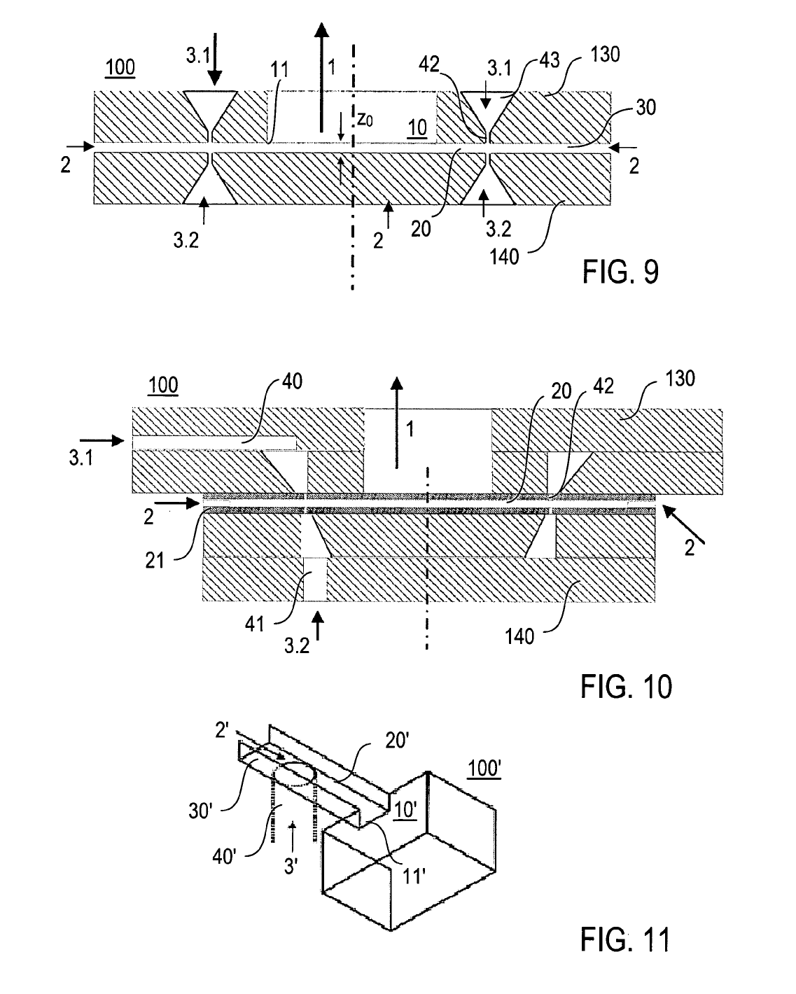

The second embodiment of the emulsifying device in accordance with the invention can be modified in accordance with the scheme shown in FIG. 4 in such a manner that the feed lines in the channel 20 flow radially into the centre, as is shown with further details in the FIGS. 9 and 10. FIG. 9 shows a construction analogous to FIG. 7 with an upper part 130 and a lower part 140, between which the channel 20, the feed line 30 and the injection bores 42 are formed. The continuous phase 2 is transported through the feed line 30 radially inward to the channel 20, where the injection of the dispersed phases 3.1, 3.2 takes place on both sides. The feed lines flowing radially inward in the channel 20 disintegrate at the gap opening 11 of the dispersion region 10 into individual drops. The emulsion 1 formed is transported away in axial direction.

In the variant of the emulsifying device 100 shown in FIG. 10 the upper and lower parts 130, 140 are combined in order to provide the injection bores 40 and the corresponding injection lines 41, 42 from several structured plates. An azimuthally interrupted distance piece 21 is provided between the upper and lower parts 130, 140 for forming the channel 20, through which distance piece the continuous phase 2 and the dispersed phases 3.1, 3.2 flow to the channel 20.

The features of the invention disclosed in the previous description, the drawings and the claims can be significant individually as well as in combination for the realization of the invention in its different embodiments.

1. An emulsifying device for forming an emulsion with a continuous phase and at least one dispersed phase comprising:
a dispersion region for forming the emulsion,
a channel that is directed to the dispersion region and is arranged for the reception of liquid filaments of the continuous phase and the at least one dispersed phase flowing in a laminar manner,
a feed line for feeding of the continuous phase into the channel, and
at least one injection line for feeding the at least one dispersed phase into the channel,
wherein the at least one injection line is connected via a plurality of injection bores to the channel, and
wherein the dispersion region comprises a gap opening of the channel that opens into an environment of the emulsifying device.

2. The emulsifying device according to claim 1, wherein the gap opening has a course of the opening that is curved in a plane vertical to an axial reference direction (z) of the emulsifying device.

3. The emulsifying device according to claim 2, wherein the gap opening has a course of the opening that is represented by a geometrically closed curve.

4. The emulsifying device according to claim 3, wherein the gap opening has a circular course of the opening.

5. The emulsifying device according to claim 1, wherein two injection lines are provided and have injection bores opening into the channel on two opposite sides, respectively.

6. The emulsifying device according to claim 5, wherein the injection bores of one of the two injection lines are arranged offset relative to the injection bores of the other one of the injection lines.

7. The emulsifying device according to claim 1, wherein the injection bores comprise funnel-shaped injection openings.

8. The emulsifying device according to claim 7, wherein the funnel-shaped injection openings are connected by a groove.

9. The emulsifying device according to claim 1, wherein the channel runs parallel to an axial reference direction (z).

10. The emulsifying device according to claim 9, wherein the injection bores run in a plane vertically to the axial reference direction (z).

11. The emulsifying device according to claim 9, wherein the at least one injection line and the feed line are arranged concentrically relative to each other.

12. The emulsifying device according to claim 11, that has the form of a cylinder wherein the at least one injection line and the feed line are arranged concentrically relative to each other and the gap opening of the channel is arranged in its front side.

13. The emulsifying device according to claim 1, wherein the channel runs in a plane vertically to an axial reference direction (z).

14. The emulsifying device according to claim 13, wherein the channel runs radially on all sides from the feed line to a circumferential edge of the emulsifying device.

15. The emulsifying device according to claim 13 wherein the injection bores run parallel to the axial reference direction (z) of the emulsifying device.

16. The emulsifying device according to claim 13, wherein the channel is formed between two plates that extend vertically to the axial reference direction (z) of the emulsifying device.

17. The emulsifying device according to claim 16, wherein the injection bores are provided in one of the plates and open into the channel on one side.

18. The emulsifying device according to claim 16, wherein the injection bores are provided in both plates and open into the channel on both sides.

19. The emulsifying device according to claim 18, wherein the injection bores are arranged staggered relative to each other in both plates.

20. A process for forming an emulsion with a continuous phase and at least one dispersed phase with an emulsifying device, with the steps:
feeding of the continuous phase through a feed line into a channel,
feeding of the at least one dispersed phase through at least one injection line into the channel, said feeding step including an injection of the at least one dispersed phase via a plurality of injection bores into the channel,
forming of liquid filaments of the continuous phase and of the at least one dispersed phase, which liquid filaments flow in a laminar manner adjacent to each other through the channel to a dispersion region, and
forming of the emulsion from the continuous phase and the at least one dispersed phase in the dispersion region,
wherein said steps of forming the emulsion comprise an exiting of the continuous phase and of the at least one dispersed phase through the gap opening of the channel into an environment of the emulsifying device.

21. The process according to claim 20, wherein at least one dispersed phase is fed through injection bores to two opposite sides of the channel.

22. The process according to claim 21, wherein the at least one dispersed phase is fed through two separate injection lines into the injection bores on both sides of the channel.

23. The process according to claim 20, wherein the exiting of the continuous phase and of the at least one dispersed phase is provided through the gap opening of the channel in a direction parallel to an axial reference direction (z).

24. The process according to claim 21, wherein the exiting of the continuous phase and of the at least one dispersed phase is provided through the gap opening of the channel in a plane vertical to an axial reference direction (z).

25. The process according to claim 21, wherein the feeding of two dispersed phases into the channel is provided and a mixing of the dispersed phases is formed during the exiting of the continuous phase and of the dispersed phases through the gap opening of the channel.

26. The process according to claim 25, comprising the step:
adjustment of a predetermined mixing ratio of the dispersed phases.

27. The process according to claim 26, wherein the adjustment of the predetermined mixing ratio of the dispersed phases comprises an adjustment of a viscosity of the dispersed phases, of a filling pressure and/or of a delivery amount of the dispersed phases.
